(19) United States
(12) Patent Application Publication
(10) Pub. No.: US 2019/0370862 A1
(43) Pub. Date: Dec. 5, 2019

(54) APPARATUS FOR SETTING ADVERTISEMENT TIME SLOT AND METHOD THEREOF

(71) Applicant: LG ELECTRONICS INC., Seoul (KR)

(72) Inventors: Jin SEO, Incheon (KR); Sang Mi SHIN, Seoul (KR)

(73) Assignee: LG ELECTRONICS INC., Seoul (KR)

(21) Appl. No.: 16/541,088

(22) Filed: Aug. 14, 2019

(30) Foreign Application Priority Data
Jul. 2, 2019 (KR) 10-2019-0079170

(51) Int. Cl. G06Q 30/02; B60R 13/00; G01C 21/34; G09F 21/04; G09F 25/00

(52) U.S. Cl. CPC G06Q 30/0266; G06Q 30/0264; G09F 25/00; G01C 21/34; G09F 21/04; B60R 13/00

(57) ABSTRACT

An apparatus for setting an advertisement time slot, the apparatus transmitting and receiving data in connection with a vehicle device which provides driving information up to a destination of a vehicle and an advertisement server, is provided. The apparatus according to an embodiment includes a communicator configured to communicate with the advertisement server, an output unit configured to output at least one of an image or a sound, and a controller configured to receive driving information from the vehicle device, determine an advertisement time slot based on the driving information, and generate advertisement time slot information, which is information on the determined advertisement time slot. The communicator is further configured to transmit the advertisement time slot information generated by the controller to the advertisement server and receive advertisement information assigned to the advertisement time slot from the advertisement server, and the controller is further configured to cause the output unit to output the received advertisement information during the advertisement time slot to which the received advertisement information is assigned. At least one among an autonomous driving vehicle, a user terminal, and a server according to embodiments of the present disclosure may be associated or integrated with an artificial intelligence module, a drone (unmanned aerial vehicle (UAV)), a robot, an augmented reality (AR) device, a virtual reality (VR) device, a 5G service related device, and the like.

### CROSS-REFERENCE TO RELATED APPLICATIONS

This present application claims benefit of priority to Korean Patent Application No. 10-2019-0079170, entitled “APPARATUS FOR SETTING ADVERTISEMENT TIME SLOT AND METHOD THEREOF” and filed on Jul. 2, 2019, in the Korean Intellectual Property Office, the entire disclosure of which is incorporated herein by reference.

### BACKGROUND

### 1. Technical Field

The present disclosure relates to an advertisement time slot setting apparatus for setting an advertisement time slot by analyzing an environment inside a vehicle while the vehicle is driving, and setting, as an advertisement time slot, an interval during which a passenger in the vehicle is able to watch or listen to an advertisement, which is determined according to the analyzing result, and a method thereof.

### 2. Description of Related Art

Attempts in various aspects have been made to insert advertisements into audio or video content of electronic apparatuses capable of providing audio or video content, as a way of increasing the effectiveness of listening to or watching the advertisements.

As one example of a method for providing advertisements through a typical electronic apparatus, U.S. Pat. Registration No. 8,626,588 discloses a method in which tones, markers, and the like of audio content being reproduced are analyzed in order to determine a time slot during which a user can effectively listen to an advertisement, and based on the analysis, an advertisement may be provided using an interval into which the advertisement can be inserted, such as a stop interval between music sections.

In the method for determining an advertisement time slot by analyzing the tones, the markers, and the like of audio content itself disclosed in U.S. Pat. No. 8,626,588, there is no consideration of an environment in which an audio content is reproduced during driving of a vehicle. Therefore, the effectiveness of the advertisement may be degraded due to listening disruption elements caused by external elements other than the audio content, such as external noises, navigation voice guidance, and audio guidance related to driving status and safety such as an advanced driver assistant system (ADAS) alarm sound, while driving.

In addition, for reasons of safety, audio systems provided to vehicles may include a function of lowering the volume of the audio content temporarily when navigation voice guidance or an ADAS alarm sound occurs, in association with electronic devices of the vehicle. Therefore, even if an optimal advertisement time slot is set by analyzing the tones and the like of the audio content, there are difficulties in delivering an audio advertisement to a passenger in a vehicle while the guidance or the alarm sound is being outputted, due to the low volume. In addition, there are difficulties in smoothly delivering audio and video advertisements to the passenger when a driver needs to focus on driving, for example, while driving on an unpaved road.

Therefore, there are difficulties facing an advertiser desiring to increase the effectiveness of an advertisement.

Accordingly, there is a need for a technique for a determining a time slot for effectively delivering an advertisement to a driver by reflecting information on a time period during which guidance or an alarm sound frequently occurs according a driving environment, and a time period during which the driver needs to focus on driving.

### SUMMARY OF THE INVENTION

An aspect of the present disclosure is to address shortcomings in the related art described above in which an advertisement time slot is determined by analyzing only the characteristics of content being reproduced in a vehicle, by providing an advertisement time slot setting apparatus and method capable of determining a time slot appropriate for an advertisement in consideration of the overall driving status of a vehicle.

Another aspect of the present disclosure is to provide an advertisement time slot setting apparatus and method capable of identifying a time period during which a vehicle passenger can focus on watching or listening to an advertisement by reflecting the characteristics of content being reproduced in a vehicle as well as the driving status of the vehicle, determining the identified time period as an advertisement time slot, and informing an advertiser of the determined advertisement time slot.

It will be appreciated by those skilled in the art that aspects to be achieved by the present disclosure are not limited to what has been disclosed hereinabove, and other aspects will be more clearly understood from the following detailed description below.

An apparatus for setting an advertisement time slot according to an embodiment of the present disclosure is configured to determine a time during which a passenger can focus on an advertisement as an advertisement time slot based on driving information of a vehicle, and output advertisement information to the passenger during the determined advertisement time slot.

In more detail, this embodiment of the present disclosure may provide an apparatus for setting an advertisement time slot. The apparatus may transmit and receive data in connection with a vehicle device which provides driving information up to a destination of a vehicle and an advertisement server, and may include a communicator configured to communicate with the advertisement server, an output unit configured to output at least one of an image or a sound, and a controller configured to receive driving information from the vehicle device, determine an advertisement time slot based on the driving information, and generate advertisement time slot information, which is information on the determined advertisement time slot. The communicator may be further configured to transmit the advertisement time slot information generated by the controller to the advertisement server, and receive advertisement information assigned to the advertisement time slot from the advertisement server, and the controller may be further configured to cause the output unit to output the received advertisement information during the advertisement time slot to which the received advertisement information is assigned.

The controller may be further configured to determine an interval as the advertisement time slot when the interval is determined as an interval during which driving information related guidance according to a driving route of the vehicle is not being outputted, based on the driving information.

The controller may be further configured to determine an interval as the advertisement time slot when the interval is determined as an interval during which the vehicle is in an autonomous driving mode based on the driving information.

The controller may be further configured to determine an interval as the advertisement time slot when the interval is determined as an interval during which the vehicle is in a straight driving mode, based on the driving information.

The controller may be further configured to determine an interval as the advertisement time slot when the interval is determined as an interval during which the vehicle is in a traffic signal waiting mode, based on the driving information.

The apparatus may be further include a storage configured to store content in the form of at least one of an image or a sound, and the apparatus may be configured to determine an interval as a first candidate time slot when the interval is determined as an interval during which driving information related guidance according to a driving route of the vehicle is not being outputted, based on the driving information, receive the content from the storage, and determine an interval in the first candidate time slot that overlaps with an advertisement insertion interval in the content as the advertisement time slot.

The apparatus may further include a storage configured to store a plurality of content in the form of at least one of an image or a sound, and the apparatus may be configured to determine an interval as a first candidate time slot when the interval is determined as an interval during which driving information related guidance according to a driving route of the vehicle is not being outputted, based on the driving information, receive the plurality of content from the storage, and determine an interval in the first candidate time slot that overlaps with an interval before the start of a next item of content after one item of content among the plurality of content ends as the advertisement time slot.

Another embodiment of the present disclosure may provide a method for setting an advertisement time slot in an advertisement time slot setting apparatus for transmitting and receiving data in connection with a vehicle device which provides driving information up to a destination of a vehicle and an advertisement server. The method may include acts of receiving driving information from the vehicle device and determining an advertisement time slot based on the driving information, generating advertisement time slot information, which is information on the advertisement time slot determined by the act of receiving driving information and determining an advertisement time slot, transmitting the advertisement time slot information to the advertisement server and receiving advertisement information assigned to the advertisement time slot from the advertisement server, and outputting the received advertisement information during the advertisement time slot to which the received advertisement information is assigned.

The act of receiving driving information and determining an advertisement time slot may include receiving driving information from the vehicle device, and determining an interval during which driving information related guidance according to a driving route of the vehicle is not being outputted as the advertisement time slot, based on the driving information.

The act of receiving driving information and determining an advertisement time slot may include receiving driving information from the vehicle device, and determining an interval during which the vehicle is in an autonomous driving mode as the advertisement time slot, based on the driving information.

The act of receiving driving information and determining an advertisement time slot may include receiving driving information from the vehicle device, and determining an interval during which the vehicle is in a straight driving mode as the advertisement time slot, based on the driving information.

The act of receiving driving information and determining an advertisement time slot may include receiving driving information from the vehicle device, and determining an interval during which the vehicle is in a traffic signal waiting mode as the advertisement time slot, based on the driving information.

The method may further include storing content in the form of at least one of an image or a sound, and the act of receiving driving information and determining an advertisement time slot may include receiving driving information from the vehicle device, and based on the driving information, determining an interval that overlaps with an advertisement insertion interval in the content, during an interval during which driving information related guidance according to a driving route of the vehicle is not being outputted, as the advertisement time slot.

The method may further include storing a plurality of content in the form of at least one of an image or a sound, and the act of receiving driving information and determining an advertisement time slot may include receiving driving information from the vehicle device, and based on the driving information, determining an interval that overlaps with an interval before the start of a next item of content after one item of content among the plurality of content ends, during an interval during which driving information related guidance according to a driving route of the vehicle is not being outputted, as the advertisement time slot.

Still another embodiment of the present disclosure may provide a computer readable recording medium recording a program, as a recording medium for setting an advertisement time slot in an advertisement time slot setting apparatus for transmitting and receiving data in connection with a vehicle device for proving driving information up to a destination of a vehicle and an advertisement server. The computer readable recoding medium recording a program may include a first means configured to receive driving information from the vehicle device and determine an advertisement time slot based on the driving information, a second means configured to generate advertisement time slot information, which is information on the advertisement time slot determined by the first means, a third means configured to transmit the advertisement time slot information to the advertisement server and receive advertisement information assigned to the advertisement time slot from the advertisement server, and a fourth means configured to output the received advertisement information during the advertisement time slot to which the received advertisement information is assigned.

Details of other embodiments will be included in the detailed description and the drawings.

According to the embodiments of the present disclosure, information on a time slot during which a passenger in a vehicle can easily recognize an advertisement, in consideration of the driving status of the vehicle, may be provided to an advertisement provider. Accordingly, the advertisement provider may provide an advertisement to the passenger at the most effective time.

According to the embodiments of the present disclosure, an advertisement may be provided while avoiding an interval during which the passenger cannot easily recognize the advertisement, based on the driving status of the vehicle. Accordingly, effectiveness of the advertisement, and thus, profits, may be increased.

Embodiments of the present disclosure are not limited to the embodiments described above, and other embodiments not mentioned above will be clearly understood from the description below.

### BRIEF DESCRIPTION OF THE DRAWINGS

The foregoing and other aspects, features, and advantages of the invention, as well as the following detailed description of the embodiments, will be better understood when read in conjunction with the accompanying drawings. For the purpose of illustrating the present disclosure, there is shown in the drawings an exemplary embodiment, it being understood, however, that the present disclosure is not intended to be limited to the details shown because various modifications and structural changes may be made therein without departing from the spirit of the present disclosure and within the scope and range of equivalents of the claims. The use of the same reference numerals or symbols in different drawings indicates similar or identical items.

FIG. 1 is a view illustrating a system to which an advertisement time slot setting apparatus is applied according to an embodiment of the present disclosure.

FIG. 2 is a block diagram illustrating an advertisement time slot setting apparatus installed in a vehicle according to an embodiment of the present disclosure.

FIG. 3 is a block diagram illustrating a user interface of the advertisement time slot setting apparatus shown in FIG. 2.

FIGS. 4A to 4C are operation flowcharts illustrating a method for setting an advertisement time slot according to an embodiment of the present disclosure.

FIG. 5 is a view illustrating an operation for setting an advertisement time slot of an advertisement time slot setting apparatus according to an embodiment of the present disclosure.

FIGS. 6A to 6D are views illustrating an operation of a system to which an advertisement time slot setting apparatus is applied according to an embodiment of the present disclosure.

### DETAILED DESCRIPTION

Advantages and features of the present disclosure and methods for achieving them will become apparent from the descriptions of aspects herein below with reference to the accompanying drawings. However, the present disclosure is not limited to the aspects disclosed herein but may be implemented in various different forms. Further, the suffixes “module” and “part” for the constituent elements used in the following description are used or alternated considering ease of understanding of the specification, and do not have a distinctive meaning or role. The aspects are provided to make the description of the present disclosure thorough and to fully convey the scope of the present disclosure to those skilled in the art. It is to be noted that the scope of the present disclosure is defined only by the claims.

In relation to describing the present disclosure, when the detailed description of the relevant known technology is determined to unnecessarily obscure the gist of the present disclosure, the detailed description may be omitted.

Although the terms “first”, “second”, “third”, and the like may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

A vehicle described in this specification refers to a car, an automobile, and the like. Hereinafter, the vehicle will be exemplified as a car.

The vehicle described in the specification may include, but is not limited to, a vehicle having an internal combustion engine as a power source, a hybrid vehicle having an engine and an electric motor as a power source, and an electric vehicle having an electric motor as a power source.

FIG. 1 is a view illustrating a system to which an advertisement time slot setting apparatus is applied according to an embodiment of the present disclosure.

Referring to FIG. 1, a vehicle sharing service system may include a vehicle 1000, a user terminal 2000, and an advertisement server 3000.

Depending on the embodiment, a system to which an advertisement time slot setting apparatus is applied may include constituent elements other than the constituent elements shown in FIG. 1, or may not include some of the constituent elements shown and described in FIG. 1.

An advertisement time slot setting apparatus according to an embodiment may be mounted on the vehicle 1000, which is equipped with a steering input device for controlling a wheel rotated by a power source and a driving direction. The vehicle 1000 may be capable of autonomous driving.

The advertisement time slot setting apparatus according to this embodiment may be mounted on the user terminal 2000, which is carried by a user who has entered a vehicle. The user terminal 2000 may be a portable device such as a laptop computer, a mobile phone, a personal digital assistant (PDA), a smart phone, and a multimedia device, or a non-portable device such as a personal computer (PC) or a vehicle-mounted device.

The vehicle 1000 and the user terminal 2000 may receive, from the advertisement server 300, information provided from another vehicle to the advertisement server 300.

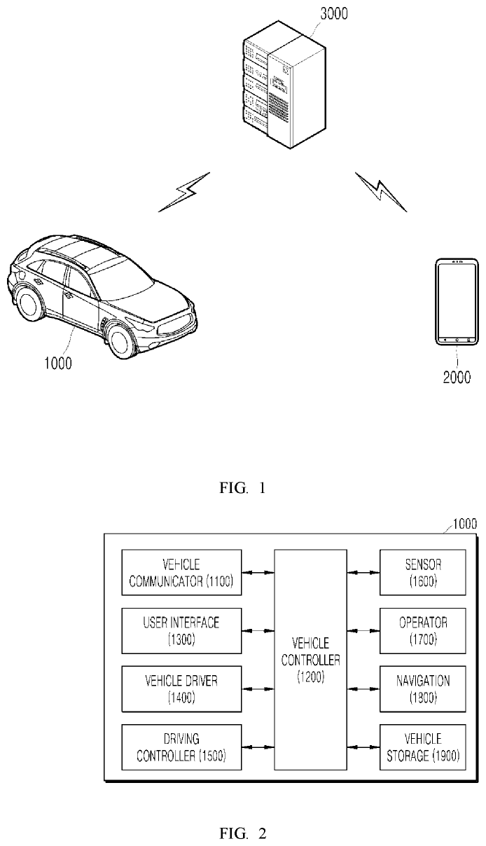

FIG. 2 is a block diagram illustrating an advertisement time slot setting apparatus installed in a vehicle 1000 according to an embodiment of the present disclosure.

Referring to FIG. 2, an advertisement time slot setting apparatus may include a vehicle communicator 1100, a vehicle controller 1200, a user interface 1300, a vehicle driver 1400, a driving controller 1500, a sensor 1600, an operator 1700, a navigation 1800, and a vehicle storage 1900.

Depending on the embodiment, a system to which an advertisement time slot setting apparatus is applied may include constituent elements other than the constituent elements shown and described in FIG. 2, or may not include some of the constituent elements shown and described in FIG. 2.

A mode of the vehicle 1000 may be changed from an autonomous driving mode to a manual mode, or the manual mode to the autonomous driving mode, according a driving situation. The driving status may be determined based on at least one among information received through the vehicle communicator 1100, external object information detected by an object detection module (not shown), or navigation information obtained by the navigation 1800.

The mode of the vehicle 1000 may be changed from the autonomous driving mode to the manual mode, or from the manual mode to the autonomous driving mode, according to a user input received through the user interface 1300.

The mode of the vehicle 1000 may be changed from the manual mode to the autonomous driving mode, or from the autonomous driving mode to the manual mode, based on information, data, and signals provided from an external device such as the user terminal 2000.

When the vehicle 1000 is operated in the autonomous driving mode, the vehicle 1000 may be operated under the control of the operator 1700 that controls driving, parking, and unparking. When the vehicle 1000 is operated in the manual mode, the vehicle 1000 may be operated by an input of a driver's mechanical driving operation through the driving controller 1500.

The vehicle communicator 1100 may be a module for performing communication with an external device. Examples of the external device may include another vehicle, the user terminal 2000, and the advertisement server 3000.

The vehicle communicator 1100 may transmit advertisement time slot information generated by the vehicle controller 1200 to the advertisement server 3000, and receive advertisement information assigned to the advertisement time slot from the advertisement server 3000.

The vehicle communicator 1100 may include at least one among a transmission antenna, a reception antenna, a radio frequency (RF) circuit capable of implementing various communication protocols, and an RF element in order to perform communication.

The vehicle communicator 1100 may include a short range communication module, a position information module, a V2X communication module, an optical communication module, a broadcast transmission/reception module, and an Intelligent Transport Systems (ITS) communication module.

Depending on the embodiment, the vehicle communicator 1100 may further include modules other than the modules to be described, or may not include some of the modules to be described.

The vehicle communicator 1100 may support short-range communication by using at least one among Bluetooth™, Radio Frequency Identification (RFID), Infrared Data Association (IrDA), Ultra WideBand (UWB), ZigBee, Near Field Communication (NFC), Wireless-Fidelity (Wi-Fi), Wi-Fi Direct, and Wireless Universal Serial Bus (Wireless USB) technologies.

The vehicle communicator 1100 may form short-range wireless communication networks so as to perform short-range communication between the vehicle 1000 and at least one external device.

The vehicle communication unit 1100 may include a Global Positioning System (GPS) module or a Differential Global Positioning System (DGPS) module for obtaining location information of the vehicle 1000.

The vehicle communicator 1100 may include a module for supporting wireless communication between the vehicle 1000 and a server (V2I: vehicle to infrastructure), communication with another vehicle (V2V: vehicle to vehicle) or communication with a pedestrian (V2P: vehicle to pedestrian). That is, the vehicle communicator 1100 may include a V2X communication module. The V2X communication module may include an RF circuit capable of implementing V2I, V2V, and V2P communication protocols.

The vehicle communicator 1100 may include an optical communication module for performing communication with an external device via light. The optical communication module may include both a light transmitting module for converting electrical signals into optical signals and transmitting the optical signals to the outside, and a light receiving module for converting the received optical signals into electrical signals.

According to an embodiment, the light transmitting module may be integrally formed with a lamp included in the vehicle 1000.

The vehicle communicator 1100 may include a broadcast communication module for receiving broadcast signals from an external broadcast management server, or transmitting broadcast signals to the broadcast management server through broadcast channels. Examples of the broadcast channels may include a satellite channel and a terrestrial channel Example of the broadcast signal may include a TV broadcast signal, a radio broadcast signal, and a data broadcast signal.

The vehicle communicator 1100 may include an ITS communication module that exchanges information, data or signals with a traffic system. The ITS communication module may provide the obtained information and data to the traffic system. The ITS communication module may receive information, data, or signals from the traffic system. For example, the ITS communication module may receive road traffic information from the communication system and provide the road traffic information to the vehicle controller 1200. For example, the ITS communication module may receive control signals from the traffic system and provide the control signals to the vehicle controller 1200 or a processor provided in the vehicle 1000.

Depending on the embodiment, the overall operation of each module of the vehicle communicator 1100 may be controlled by a separate process provided in the vehicle communicator 1100. The vehicle communicator 1100 may include a plurality of processors, or may not include a processor. When a processor is not included in the vehicle communicator 1100, the vehicle communicator 1100 may be operated by either a processor of another apparatus in the vehicle 1000 or the vehicle controller 1200.

The vehicle communicator 1100 may, together with the user interface 1300, implement a vehicle-use display device. In this case, the vehicle-use display device may be referred to as a telematics device or an audio video navigation (AVN) device.

The vehicle communicator 1100 may transmit specific information over a 5G network when the vehicle 1000 is operated in the autonomous driving mode.

The specific information may include autonomous driving related information.

The autonomous driving related information may be information directly related to the driving control of the vehicle. For example, the autonomous driving related information may include at least one among object data indicating an object near the vehicle, map data, vehicle status data, vehicle location data, and driving plan data.

The autonomous driving related information may further include service information necessary for autonomous driving. For example, the specific information may include information on a destination inputted through the user terminal 2000 and a safety rating of the vehicle.

In addition, the 5G network may determine whether a vehicle is to be remotely controlled.

The 5G network may include a server or a module for performing remote control related to autonomous driving.

The 5G network may transmit information (or a signal) related to the remote control to an autonomous driving vehicle.

As described above, information related to the remote control may be a signal directly applied to the autonomous driving vehicle, and may further include service information necessary for autonomous driving. The autonomous driving vehicle according to this embodiment may receive service information such as insurance for each interval selected on a driving route and risk interval information, through a server connected to the 5G network to provide services related to the autonomous driving.

An essential process for performing 5G communication between the autonomous driving vehicle 1000 and the 5G network (for example, an initial access process between the vehicle 1000 and the 5G network) will be briefly described below.

An example of application operations through the autonomous driving vehicle 1000 performed in the 5G communication system and the 5G network is as follows.

The vehicle 1000 may perform an initial access process with the 5G network (initial access step). The initial access process may include a cell search process for downlink (DL) synchronization acquisition and a process for obtaining system information.

The vehicle 1000 may perform a random access process with the 5G network (random access step). The random access process may include a process for uplink (UL) synchronization acquisition or a preamble transmission process for UL data transmission, or a random access response receiving process.

The 5G network may transmit an Uplink (UL) grant for scheduling transmission of specific information to the autonomous driving vehicle 1000 (UL grant receiving step).

The process in which the vehicle 1000 receives the UL grant may include a scheduling process for receiving a time/frequency source for the transmission of the UL data over the 5G network.

The autonomous driving vehicle 1000 may transmit specific information over the 5G network based on the UL grant (specific information transmission step).

The 5G network may determine whether the vehicle 1000 is to be remotely controlled based on the specific information transmitted from the vehicle 1000 (vehicle remote control determination step).

The autonomous driving vehicle 1000 may receive the DL grant through a physical DL control channel for receiving a response on pre-transmitted specific information from the 5G network (DL grant receiving step).

The 5G network may transmit information (or a signal) related to the remote control to the autonomous driving vehicle 1000 based on the DL grant (remote control related information transmission step).

A process in which the initial access process and/or the random access process between the 5G network and the autonomous driving vehicle 1000 is combined with the DL grant receiving process has been exemplified. However, the present disclosure is not limited thereto.

For example, the initial access process and/or the random access process may be performed through the initial access step, the UL grant receiving step, the specific information transmission step, the vehicle remote control determination step, and the remote control related information transmission step. In addition, for example, the initial access process and/or the random access process may be performed through the random access step, the UL grant receiving step, the specific information transmission step, the vehicle remote control determination step, and the remote control related information transmission step. The autonomous driving vehicle 1000 may be controlled by the combination of an AI operation and the DL grant receiving process through the specific information transmission step, the vehicle remote control determination step, the DL grant receiving step, and the remote control related information transmission step.

The operation of the autonomous driving vehicle 1000 described above is merely exemplary, but the present disclosure is not limited thereto.

For example, the operation of the autonomous driving vehicle 1000 may be performed by selectively combining the initial access step, the random access step, the UL grant receiving step, or the DL grant receiving step with the specific information transmission step, or the remote control related information transmission step. The operation of the autonomous driving vehicle 1000 may include the random access step, the UL grant receiving step, the specific information transmission step, and the remote control related information transmission step. The operation of the autonomous driving vehicle 1000 may include the initial access step, the random access step, the specific information transmission step, and the remote control related information transmission step. The operation of the autonomous driving vehicle 1000 may include the UL grant receiving step, the specific information transmission step, the DL grant receiving step, and the remote control related information transmission step.

The vehicle 1000 including an autonomous driving module may perform an initial access process with the 5G network based on Synchronization Signal Block (SSB) in order to acquire DL synchronization and system information (initial access step).

The autonomous driving vehicle 1000 may perform a random access process with the 5G network for UL synchronization acquisition and/or UL transmission (random access step).

The autonomous driving vehicle 1000 may receive the UL grant from the 5G network for transmitting specific information (UL grant receiving step).

The autonomous driving vehicle 1000 may transmit the specific information to the 5G network based on the UL grant (specific information transmission step).

The autonomous driving vehicle 1000 may receive the DL grant for receiving a response to the specific information from the 5G network (DL grant receiving step).

The autonomous driving vehicle 1000 may receive remote control related information (or a signal) from the 5G network based on the DL grant (remote control related information receiving step).

A beam management (BM) process may be added to the initial access step, and a beam failure recovery process associated with Physical Random Access Channel (PRACH) transmission may be added to the random access step. QCL (Quasi Co-Located) relation may be added with respect to the beam reception direction of a Physical Downlink Control Channel (PDCCH) including the UL grant in the UL grant receiving step, and QCL relation may be added with respect to the beam transmission direction of the Physical Uplink Control Channel (PUCCH)/Physical Uplink Shared Channel (PUSCH) including specific information in the specific information transmission step. In addition, QCL relation may be added with respect to the beam reception direction of the PDCCH including the DL grant in the DL grant receiving step.

The autonomous driving vehicle 1000 may perform an initial access process with the 5G network based on SSB for obtaining DL synchronization and system information (initial access step).

The autonomous driving vehicle 1000 may perform a random access process with the 5G network for UL synchronization acquisition and/or UL transmission (random access step).

The autonomous driving vehicle 1000 may transmit specific information based on a configured grant to the 5G network (UL grant receiving step). In other words, the autonomous driving vehicle 1000 may receive the configured grant instead of receiving the UL grant from the 5G network.

The autonomous driving vehicle 1000 may receive the remote control related information (or a signal) from the 5G network based on the configured grant (remote control related information receiving step).

The autonomous driving vehicle 1000 may perform an initial access process with the 5G network based on the SSB for acquiring the DL synchronization and the system information (initial access step).

The autonomous driving vehicle 1000 may perform a random access process with the 5G network for UL synchronization acquisition and/or UL transmission (random access step).

In addition, the autonomous driving vehicle 1000 may receive Downlink Preemption (DL) and Information Element (IE) from the 5G network (DL Preemption IE reception step).

The autonomous driving vehicle 1000 may receive DCI (Downlink Control Information) format 2_1 including preemption indication based on the DL preemption IE from the 5G network (DCI format 2_1 receiving step).

The autonomous driving vehicle 1000 may not perform (or expect or assume) the reception of eMBB data in the resource (PRB and/or OFDM symbol) indicated by the pre-emption indication (step of not receiving eMBB data).

The autonomous driving vehicle 1000 may receive the UL grant over the 5G network for transmitting specific information (UL grant receiving step).

The autonomous driving vehicle 1000 may transmit the specific information to the 5G network based on the UL grant (specific information transmission step).

The autonomous driving vehicle 1000 may receive the DL grant from the 5G network for receiving a response to the specific information (DL grant receiving step).

The autonomous driving vehicle 1000 may receive the remote control related information (or a signal) from the 5G network based on the DL grant (remote control related information receiving step).

The autonomous driving vehicle 1000 may perform an initial access process with the 5G network based on SSB for acquiring DL synchronization and system information (initial access step).

The autonomous driving vehicle 1000 may perform a random access process with the 5G network for UL synchronization acquisition and/or UL transmission (random access step).

The autonomous driving vehicle 1000 may receive the UL grant over the 5G network for transmitting specific information (UL grant receiving step).

When specific information is transmitted repeatedly, the UL grant may include information on the number of repetitions, and the specific information may be repeatedly transmitted based on information on the number of repetitions (specific information repetition transmission step).

The autonomous driving vehicle 1000 may transmit the specific information to the 5G network based on the UL grant.

The repeated transmission of the specific information may be performed by frequency hopping, and the first transmission of the specific information may be performed from a first frequency source, and the second transmission of the specific information may be performed from a second frequency source.

The specific information may be transmitted through Narrowband of Resource Block (6RB) and Resource Block (1RB).

The autonomous driving vehicle 1000 may receive the DL grant for receiving a response to the specific information from the 5G network (DL grant receiving step).

The autonomous driving vehicle 1000 may receive the remote control related information (or signal) from the 5G network based on the DL grant (remote control related information receiving step).

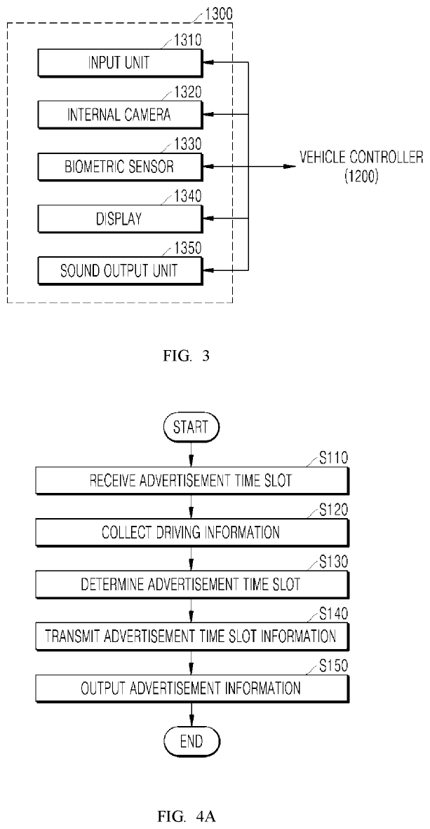

The above-described 5G communication technique can be applied in combination with the embodiment proposed in this specification, which will be described in FIG. 1 to FIG. 6D, or supplemented to specify or clarify the technical feature of the embodiment proposed in this specification.

The vehicle 1000 may be connected to an external server through a communication network, and may be capable of moving along a predetermined route without a driver's intervention by using an autonomous driving technique.

In the embodiment described below, a user may be interpreted as a driver, a passenger, or an owner of a user terminal.

While the vehicle 1000 is driving in the autonomous driving mode, the type and frequency of accident occurrence may depend on the capability of the vehicle 1000 of sensing dangerous elements in the vicinity in real time. The route to the destination may include intervals with different levels of risk based on various causes, such as weather, terrain characteristic, and traffic congestion.

At least one among an autonomous driving vehicle, a user terminal, and a server according to embodiments of the present disclosure may be associated or integrated with an artificial intelligence module, a drone (unmanned aerial vehicle (UAV)), a robot, an augmented reality (AR) device, a virtual reality (VR) device, a 5G service related device, and the like.

For example, the vehicle 1000 may operate in association with at least one artificial intelligence module or robot included in the vehicle 1000 in the autonomous driving mode.

For example, the vehicle 1000 may interact with at least one robot. The robot may be an autonomous mobile robot (AMR) capable of driving by itself. Being capable of driving by itself, the AMR may freely move, and may include a plurality of sensors so as to avoid obstacles during traveling. The AMR may be a flying robot (such as a drone) equipped with a flight device. The AMR may be a wheel-type robot equipped with at least one wheel, and which is moved through the rotation of the at least one wheel. The AMR may be a leg-type robot equipped with at least one leg, and which is moved using the at least one leg.

The robot may function as a device that enhances the convenience of a user of a vehicle. For example, the robot may move a load placed in the vehicle 1000 to a final destination. For example, the robot may perform a function of providing route guidance to a final destination to a user who alights from the vehicle 1000. For example, the robot may perform a function of transporting the user who alights from the vehicle 1000 to the final destination

At least one electronic apparatus included in the vehicle 1000 may communicate with the robot through a communication device.

At least one electronic apparatus included in the vehicle 1000 may provide, to the robot, data processed by the at least one electronic apparatus included in the vehicle 1000. For example, at least one electronic apparatus included in the vehicle 1000 may provide, to the robot, at least one among object data indicating an object near the vehicle, HD map data, vehicle status data, vehicle position data, and driving plan data.

At least one electronic apparatus included in the vehicle 1000 may receive, from the robot, data processed by the robot. At least one electronic apparatus included in the vehicle 1000 may receive at least one among sensing data sensed by the robot, object data, robot status data, robot location data, and robot movement plan data.

At least one electronic apparatus included in the vehicle 1000 may generate a control signal based on data received from the robot. For example, at least one electronic apparatus included in the vehicle may compare information on the object generated by an object detection device with information on the object generated by the robot, and generate a control signal based on the comparison result. At least one electronic apparatus included in the vehicle 1000 may generate a control signal so that interference between the vehicle movement route and the robot movement route may not occur.

At least one electronic apparatus included in the vehicle 1000 may include a software module or a hardware module for implementing an artificial intelligence (AI) (hereinafter referred to as an artificial intelligence module). At least one electronic apparatus included in the vehicle 1000 may input obtained data into the artificial intelligence module, and use data outputted from the artificial intelligence module.

The artificial intelligence module may perform machine learning of input data by using at least one artificial neural network (ANN). The artificial intelligence module may output driving plan data through machine learning of input data.

At least one electronic apparatus included in the vehicle 1000 may generate a control signal based on the data outputted from the artificial intelligence module.

According to the embodiment, at least one electronic apparatus included in the vehicle 1000 may receive data processed by an artificial intelligence from an external device through a communication device. At least one electronic apparatus included in the vehicle may generate a control signal based on the data processed by the artificial intelligence.

The vehicle controller 1200 may be provided with driving information from a device mounted on the vehicle 1000 so as to determine an advertisement time slot based on the driving information and generate advertisement time slot information, which is information on the determined advertisement time slot.

The vehicle controller 1200 may transmit the generated advertisement time slot information to the advertisement server 3000 through the vehicle communicator 1100.

The vehicle controller 1200 may receive advertisement information assigned to the advertisement time slot according to advertisement time slot information transmitted from the advertisement server 3000 in advance through the vehicle communicator 1100. The vehicle controller 1200 may cause the received advertisement information to be outputted during the assigned advertisement time slot through the display 1340 for outputting image or the sound output unit 1350 for outputting sound.

Based on the driving information, the vehicle controller 1200 may determine an interval as an advertisement time slot when the interval is determined as an interval during which the driving information related guidance of the display 1340 or the sound output unit 1350 according to the driving route of the vehicle 1000 is not being outputted,

Based on the driving information, the vehicle controller 1200 may determine an interval as an advertisement time slot when the interval is determined as an interval during which the vehicle 1000 is in the autonomous driving mode under the control of the operator 1700.

Based on the driving information, the vehicle controller 1200 may determine an interval as an advertisement time slot when the interval is determined as an interval during which the vehicle 1000 is in the straight driving mode.

Based on the driving information, the vehicle controller 1200 may determine an interval as an advertisement time slot when the interval is determined as an interval during which the vehicle 1000 is the traffic signal waiting mode.

Based on the driving information, the vehicle controller 1200 may determine an interval as an advertisement time slot when the interval is determined as an interval during which the user's concentration is relatively less required, other than the straight driving situation and the traffic signal waiting situation.

Based on the driving information, the vehicle controller 1200 may determine an interval as a first candidate time slot when the interval is determined as an interval during which the driving information related guidance of the display 1340 or the sound output unit 1350 according to the driving route of the vehicle 1000 is not being outputted, and determine an interval during which the determined first candidate time slot overlaps with an advertisement insertion interval in content to be used by a user as an advertisement time slot.

Based on the driving information, the vehicle controller 1200 may determine an interval as a first candidate time slot when the interval is determined as an interval during which the driving information related guidance of the display 1340 or the sound output unit 1350 according to the driving route of the vehicle 1000 is not being outputted, and determine, as an advertisement time slot, an interval during which the determined first candidate time slot overlaps with an interval before the beginning of a next item of content after the end of one item of content among a plurality of content to be used by a user.

The vehicle controller 1200 may be implemented using at least one among application specific integrated circuits (ASICs), digital signal processors (DSPs), digital signal processing devices (DSPDs), programmable logic devices (PLDs), field [programmable gate arrays (FPGAs), processors, controllers, micro-controllers, microprocessors, and other electronic units for performing other functions.

The user interface 1300 may allow interaction between the vehicle 1000 and a vehicle user, receive an input signal of the user, transmit the received input signal to the vehicle controller 1200, and provide information included in the vehicle 1000 to the user under the control of the vehicle controller 1200. The user interface 1300 may include an input unit 1310, an internal camera 1320, a biometric sensor 1330, a display 1340 and a sound output unit 1350, but the present disclosure is not limited thereto.

The input unit 130 may receive information from a user, and data collected by the input unit 1310 may be analyzed by the vehicle controller 1200 and processed by a control command of the user.

The input unit 1310 may be disposed inside the vehicle. For example, the input unit 1310 may be disposed in one area of a steering wheel, one area of an instrument panel, one area of a seat, one area of each pillar, one area of a door, one area of a center console, one area of a head lining, one area of a sun visor, one area of a windshield, or one area of a window.

The input unit 1310 may include a voice input module, a gesture input module, a touch input module, and a mechanical input module.

The voice input module may convert a voice input of a user into an electrical signal. The electrical signal may be provided to the vehicle controller 1200.

The voice input module may include at least one microphone.

The gesture input module may convert a gesture input of a user into an electrical signal. The electrical signal may be provided to the vehicle controller 1200.

The gesture input module may include at least one of an infrared sensor for sensing a gesture input of the user or an image sensor.

According to an embodiment, the gesture input module may sense a three-dimensional gesture input of the user. The gesture input module may include a plurality of light output units that output infrared light, or a plurality of image sensors.

The gesture input module may detect a user's three-dimensional gesture input using a time of flight (TOF) method, a structured light method, or a disparity method.

The touch input module may convert the touch input of the user into an electrical signal. The electrical signal may be provided to the vehicle controller 1200.

The touch input module may include a touch sensor for sensing the touch input of the user.

According to the embodiment, the touch input module may be integrally embodied with the display 1340 to realize a touch screen. The touch screen may provide an input interface and an output interface between the vehicle 1000 and the user.

The mechanical input module may include at least one among a button, a dome switch, a jog wheel, and a jog switch. An electrical signal generated by the mechanical input module may be provided to the vehicle controller 1200.

The mechanical input module may be disposed, for example, on a steering wheel, a center fascia, a center console, a cockpit module, or a door.

The internal camera 1320 may obtain an image of the interior of the vehicle. The vehicle controller 1200 may sense a user state based on the image of the interior of the vehicle. The vehicle controller 1200 may obtain gaze information of the user from the image of the interior of the vehicle of the vehicle. The vehicle controller 1200 may sense a gesture of the user from the image of the interior of the vehicle.

The biometric sensor 1330 may acquire biometric information of the user. The biometric sensor 1330 may include a sensor that can acquire biometric information of the user, and may acquire biometric information such as fingerprint information and heartbeat information of the user using the sensor. The biometric information may be used for user authentication.

The output unit may be configured to generate output related to sight, hearing, or touch, and may include at least one of the display 1340, the sound output unit 1350, and a haptic output module.

The display 1340 may display graphic objects corresponding to various information.

The display 1340 may including at least one of a liquid crystal display (LCD), a thin film transistor liquid crystal display (TFT LCD), an organic light emitting diode (OLED), a flexible display, a 3D display, or an e-ink display.

The display 1340 may form an interactive layer structure with a touch input module, or may be integrally formed with the touch input module to implement a touch screen.

The display 1340 may be implemented as a head up display (HUD). When the display 1340 is implemented as an HUD, the display 1340 may include a project module, and output information through an image projected onto a windshield or a window.

The display 1340 may include a transparent display. The transparent display may be attached to a window shield or a window.

The transparent display may display a predetermined screen with a predetermined transparency. In order to be transparent, the transparent display may include, for example, at least one among a transparent thin film electroluminescent (TFEL), a transparent organic light-emitting diode (OLED), a transparent liquid crystal display (LCD), a transmissive transparent display, and a transparent light emitting diode (LED). The transparency of the transparent display may be adjusted.

The user interface 1300 may include a plurality of display modules.

The display 1340 may be disposed in one area of the steering wheel, one area of the instrument panel, one area of the seat, one area of each pillar, one area of the door, one area of the center console, one area of the head lining, or one area of the sun visor, or may be implemented on one area of the windshield or one area of the window.

The sound output unit 1350 may convert an electrical signal provided from the vehicle controller 1200 into an audio signal. The sound output unit 1350 may include at least one speaker.

The haptic output module may generate a tactile output. For example, the haptic output module may operate to vibrate a steering wheel, a seatbelt, and a seat so that the user may recognize an output.

When a processor is not included in the user interface 1300, the user interface 1300 may operate under the control of a processor of another device in the vehicle 1000 or the vehicle controller 1200.

In addition, an object detection module for detecting an object disposed outside the vehicle 1000 may be further included, and the object detection module may generate object information based on sensing data, and transmit the generated object information to the vehicle controller 1200. Examples of the object may include various objects related to the driving of the vehicle 1000, such as a lane, another vehicle, a pedestrian, a motorcycle, a traffic signal, light, a road, a structure, a speed bump, a landmark, and an animal.

The object detection module may include a camera, radio detection and ranging (Radar), light imaging detection and ranging (Lidar), an ultrasonic sensor, and an infrared sensor.

According to the embodiment, the object detection module may further include constituent elements other than the above-described constituent elements, or may not include some of the constituent elements described above.

The camera may be located at an appropriate position outside the vehicle so as to obtain an image of the outside of the vehicle. The camera may be a mono camera, a stereo camera, an around view monitoring (AVM) camera, or a 360 degree camera.

The camera may include a camera mounted in the vehicle 1000, for example, a camera mounted in a black box to capture an image near the vehicle 1000 using the camera mounted in the vehicle 1000, and provide the captured image to the vehicle controller 1200. The camera may provide an image for the operation of the object detection module.

The camera may obtain location information of an object, distance information from the object, or relative speed information of the object using various image processing algorithms

The camera may obtain the distance information from the object and the relative speed information of the object from the obtained image based on the change of the size of the object over time.

The camera may acquire the distance information and the relative speed information with respect to the object through, for example, a pin hole model and road surface profiling.

The camera may obtain the distance information from the object and the relative speed information based on disparity information from a stereo image obtained from a stereo camera.

The camera may be disposed close to a front windshield inside the vehicle in order to obtain an image in front of the vehicle. The camera may be disposed near a front bumper or a radiator grill.

The camera may be disposed close to a rear glass in the vehicle in order to obtain an image of the back of the vehicle. The camera may be disposed near a rear bumper, a trunk, or a tail gate.

The camera may be disposed close to at least one side window in the vehicle in order to obtain an image of the side of the vehicle. The camera may be disposed near a side mirror, a fender, or a door.

The camera may provide the obtained image to the vehicle controller 1200.

The vehicle controller 1200 may obtain the distance information to the object and the relative speed information based on disparity information from a stereo image obtained from a stereo camera of the camera.

The radar may include an electromagnetic wave transmitting module and an electromagnetic wave receiving module. The radar may be implemented using a pulse radar method or a continuous wave radar method in terms of radio wave emission principle. The radar may be implemented using a frequency modulated continuous wave (FMCW) method or a frequency shift keying (FSK) method according to a signal waveform in a continuous wave radar method.

The radar may detect an object based on a time-of-flight (TOF) method or a phase-shift method using an electromagnetic wave as a medium, and detect the location of the detected object, the distance to the detected object, and the relative speed of the detected object.

The radar may be disposed at an appropriate position outside the vehicle for sensing an object disposed at the front, back, or side of the vehicle.

The lidar may include a laser transmitting module, and a laser receiving module. The lidar may be embodied using the time of flight (TOF) method or in the phase-shift method.

The lidar may be implemented using a driving method or a non-driving method.

When the lidar is embodied in the driving method, the lidar may rotate by means of a motor, and detect an object near the vehicle 1000. When the lidar is implemented in the non-driving method, the lidar may detect an object within a predetermined range with respect to the vehicle 1000 by means of light steering. The vehicle 1000 may include a plurality of non-driving lidars.

The lidar may detect an object using the time of flight (TOF) method or the phase-shift method using laser light as a medium, and detect the location of the detected object, the distance from the detected object and the relative speed of the detected object.

The lidar may be disposed at an appropriate position outside the vehicle for sensing an object disposed at the front, back, or side of the vehicle.

The ultrasonic sensor may include an ultrasonic transmitting module, and an ultrasonic receiving module. The ultrasonic sensor may detect an object based on ultrasonic waves, and detect the location of the detected object, the distance from the detected object, and the relative speed of the detected object.

The ultrasonic sensor may be disposed at an appropriate position outside the vehicle for sensing an object at the front, back, or side of the vehicle.

The infrared sensor may include an infrared transmitting module, and an infrared receiving module. The infrared sensor may detect an object based on infrared light, and detect the location of the detected object, the distance from the detected object, and the relative speed of the detected object.

The infrared sensor may be disposed at an appropriate position outside the vehicle for sensing an object at the front, back, or side of the vehicle.

The vehicle controller 1200 may control the overall operation of the object detection module.

The vehicle controller 1200 may compare data sensed by the radar, the lidar, the ultrasonic sensor, and the infrared sensor with pre-stored data so as to detect or classify an object.

The vehicle controller 1200 may detect an object and perform tracking of the object based on the obtained image. The vehicle controller 1200 may perform operations such as calculation of the distance from an object and calculation of the relative speed of the object through image processing algorithms

For example, the vehicle controller 1200 may obtain the distance information from the object and the relative speed information of the object from the obtained image based on the change of size of the object over time.

For example, the vehicle controller 1200 may obtain the distance information from the object and the relative speed information of the object through, for example, a pin hole model and road surface profiling.

The vehicle controller 1200 may detect an object and perform tracking of the object based on the reflected electromagnetic wave reflected back from the object. The vehicle controller 1200 may perform operations such as calculation of the distance to the object and calculation of the relative speed of the object based on the electromagnetic waves.

The vehicle controller 1200 may detect an object, and perform tracking of the object based on the reflected laser light reflected back from the object. Based on the laser light, the vehicle controller 1200 may perform operations such as calculation of the distance to the object and calculation of the relative speed of the object based on the laser light.

The vehicle controller 1200 may detect an object and perform tracking of the object based on the reflected ultrasonic wave reflected back from the object. The vehicle controller 1200 may perform operations such as calculation of the distance to the object and calculation of the relative speed of the object based on the reflected ultrasonic wave.

The vehicle controller 1200 may detect an object and perform tracking of the object based on the reflected infrared light reflected back from the object. The vehicle controller 1200 may perform operations such as calculation of the distance to the object and calculation of the relative speed of the object based on the infrared light.

Depending on the embodiment, the object detection module may include a separate processor from the vehicle processor 1200. In addition, the radar, the lidar, the ultrasonic sensor, and the infrared sensor may each include a processor.

When a processor is included in the object detection module, the object detection module may be operated under the control of the processor controlled by the vehicle controller 1200.

The vehicle driver 1400 may electrically control the driving of various apparatuses in the vehicle 1000.

The driving controller 1500 may receive a user input for driving.

The sensor 1600 may sense the state of the vehicle 1000 using a sensor mounted on the vehicle 1000, that is, a signal related to the state of the vehicle 1000, and obtain movement route information of the vehicle 1000 according to the sensed signal. The sensor 1600 may provide the obtained movement route information to the vehicle controller 1200.

The sensor 1600 may include a posture sensor (for example, a yaw sensor, a roll sensor, and a pitch sensor), a collision sensor, a wheel sensor, a speed sensor, a tilt sensor, a weight sensor, a heading sensor, a gyro sensor, a position module, a vehicle forward/reverse movement sensor, a battery sensor, a fuel sensor, a tire sensor, a steering sensor by rotation of a steering wheel, a vehicle interior temperature sensor, a vehicle interior humidity sensor, an ultrasonic sensor, an illuminance sensor, an accelerator pedal position sensor, and a brake pedal position sensor, but is not limited thereto.

The sensor 1600 may acquire sensing signals for information such as vehicle posture information, vehicle collision information, vehicle direction information, vehicle position information (GPS information), vehicle angle information, vehicle speed information, vehicle acceleration information, vehicle tilt information, vehicle forward/reverse movement information, battery information, fuel information, tire information, vehicle lamp information, vehicle interior temperature information, vehicle interior humidity information, a steering wheel rotation angle, vehicle exterior illuminance, pressure on an acceleration pedal, and pressure on a brake pedal.

The sensor 1600 may further include an acceleration pedal sensor, a pressure sensor, an engine speed sensor, an air flow sensor (AFS), an air temperature sensor (ATS), a water temperature sensor (WTS), a throttle position sensor (TPS), a TDC sensor, a crank angle sensor (CAS), but is not limited thereto.

The sensor 1600 may generate vehicle status information based on sensing data. The vehicle status information may be information generated based on data sensed by various sensors included in the inside of the vehicle.

The vehicle status information may include at least one among posture information of the vehicle, speed information of the vehicle, tilt information of the vehicle, weight information of the vehicle, direction information of the vehicle, battery information of the vehicle, fuel information of the vehicle, tire air pressure information of the vehicle, steering information of the vehicle, vehicle interior temperature information, vehicle interior humidity information, pedal position information, and vehicle engine temperature information.

The operator 1700 may control various operations of the vehicle 1000. The operator 1700 may operate in the autonomous driving mode.

The operator 1700 may include a driving module, an unparking module, and a parking module.

Depending on the embodiment, the operator 1700 may further include constituent elements other than the constituent elements to be described, or may not include some of the constitute elements.

The operator 1700 may include a processor under the control of the vehicle controller 1200. Each module of the operator 1700 may include a processor individually.

Depending on the embodiment, when the operator 1700 is implemented as software, it may be a sub-concept of the vehicle controller 1200.

The driving module may perform driving of the vehicle 1000.

The driving module may receive object information from the object detection module, and provide a control signal to a vehicle driving module to perform the driving of the vehicle 1000.

The driving module may receive a signal from an external device through the vehicle communicator 1100, and provide a control signal to the vehicle driving module, so that the unparking of the vehicle 1000 may be performed.

In the unparking module, unparking of the vehicle 1000 may be performed.

In the unparking module, navigation information may be provided from the navigation 1800, and a control signal may be provided to the vehicle driving module, so that the unparking of the vehicle 1000 may be performed.

In the unparking module, object information may be received from the object detection module, and a control signal may be provided to the vehicle driving module, so that the parking of the vehicle 1000 may be performed.

In the unparking module, a signal may be provided from an external device through the vehicle communicator 1100, and a control signal may be provided to the vehicle driving module, so that the parking of the vehicle 1000 may be performed.

In the parking module, parking of the vehicle 1000 may be performed.

In the parking module, navigation information may be provided from the navigation 1800, and a control signal may be provided to the vehicle driving module, so that the parking of the vehicle 1000 may be performed.

In the parking module, object information may be provided from the object detection module, and a control signal may be provided to the vehicle driving module, so that the parking of the vehicle 1000 may be performed.

In the parking module, a signal may be provided from the external device through the vehicle communicator 1100, and a control signal may be provided to the vehicle driving module so that the parking of the vehicle 1000 may be performed.

The navigation 1800 may provide navigation information to the vehicle controller 1200. The navigation information may include at least one among map information, set destination information, route information according to destination setting, information on various objects on the route, lane information, and present location information of the vehicle.

The vehicle controller 1200, when the vehicle 1000 enters a parking lot, may be provided with a map of the parking lot from the navigation 1800, and may reflect a calculated movement route and fixed identification information to the parking lot map so as to generate map data.

The navigation 1800 may include a memory. The memory may store navigation information. The navigation information may be updated by information received through the vehicle communicator 1100. The navigation 1800 may be controlled by an internal processor, or may operate by receiving an external signal, for example, a control signal from the vehicle controller 1200, but the present disclosure is not limited thereto.

The driving module of the operator 1700 may be provided with the navigation information from the navigation 1800, and may provide a control signal to the vehicle driving module so that driving of the vehicle 1000 may be performed.

The vehicle storage 1900 may be electrically connected to the vehicle controller 1200. The vehicle storage 1900 may store basic data for each unit of an advertisement time slot setting apparatus, control data for operation control of each unit of an advertisement time slot apparatus, and input/output data.

The vehicle storage 1900 may store content in the form of at least one of an image or a sound, and content to be stored may include a plurality of content.

The vehicle storage 1900 may be various storage devices such as a ROM, a RAM, an EPROM, a flash drive, and a hard drive, in terms of hardware. The vehicle storage 1900 may store various data for the overall operation of the vehicle 100, such as a program for processing or controlling the vehicle controller 1200. The vehicle storage 1900 may be integrally formed with the vehicle controller 1200, or implemented as a sub-component of the vehicle controller 1200.

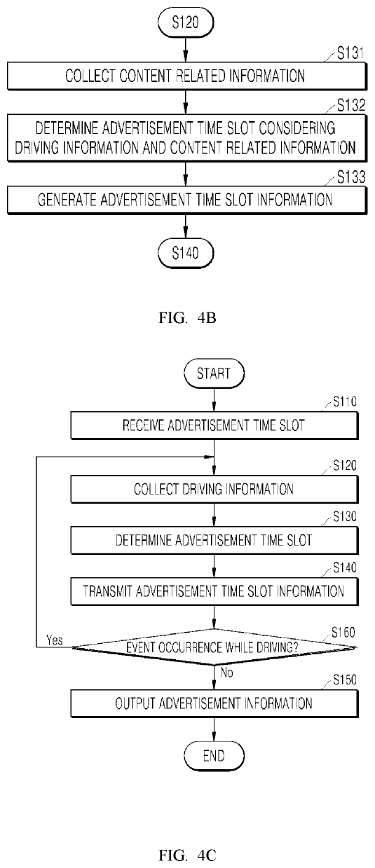

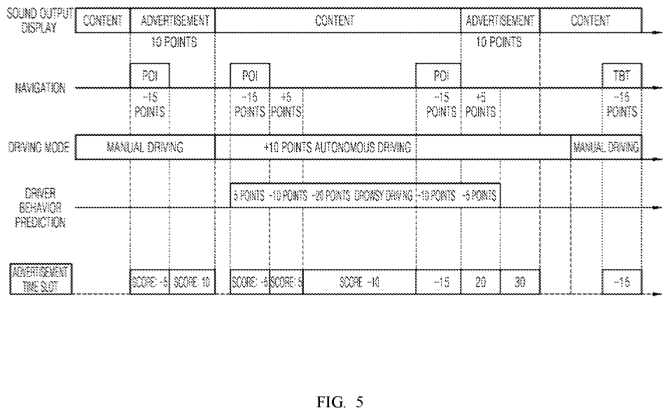

FIGS. 4A to 4C are operation flowcharts illustrating a method for setting an advertisement time slot according to an embodiment of the present disclosure.

The method for setting an advertisement time slot may include steps other than the constituent elements shown and described in FIGS. 4A to 4C, or may not include some of the steps shown in FIGS. 4A to 4C below.

The vehicle controller 1200 may receive a signal for requesting an advertisement time slot from an advertisement server 3000 through a vehicle communicator 1100 in step S110.

The vehicle controller 1200 may be provided with driving information from at least one among a vehicle communicator 1100, the user interface 1300, the vehicle driver 1400, the driving controller 1500, the sensor 1600, the operator 1700, the navigation 1800, and the vehicle storage 1900 mounted in the vehicle 1000 in step S120.

The vehicle controller 1200 may determine an advertisement time slot based on the provided driving information in step S130. The vehicle controller 1200 may determine an interval during which information guidance according to a driving route of the vehicle 1000 is not being outputted as an advertisement time slot, based on the driving information provided by at least one of the user interface 1300 or the navigation 1800.

The vehicle controller 1200 may determine an interval during which the vehicle 1000 is in the autonomous driving mode as an advertisement time slot based on the driving information provided by at least one among the user interface 1300, the driving controller 1500, and the operator 1700.

The vehicle controller 1200 may determine an interval during which the vehicle 1000 is in the straight driving mode or the traffic signal waiting mode as an advertisement time slot based on the driving information provided by at least one among the user interface 1300, the vehicle driver 1400, the driving controller 1500, the sensor 1600, the operator 1700, and the navigation 1800.

The vehicle controller 1200 may store content in the form of at least one of an image or a sound, or a plurality of content, in the vehicle storage 1900.

The vehicle controller 1200 may collect content-related information stored in the vehicle storage 1900 in step S131.

The vehicle controller 1200, based on the driving information provided from at least one of the user interface 1300 or the navigation 180, may determine an interval overlapping with an advertisement insertion interval marked with a predetermined marker in the content, during an interval during which information guidance according to the driving route of the vehicle 1000 is not being outputted, as an advertisement time slot, or determine an interval overlapping with an interval before the beginning of the next content after the end of one item of content among the plurality of content as an advertisement time slot in step S132.

The vehicle controller 1200 may generate advertisement time slot information, which is information on the determined advertisement time slot, in step S133.

The vehicle controller 1200 may transmit the generated advertisement time slot information to the advertisement server 3000 through the vehicle communicator 1100, and receive advertisement information assigned to the advertisement time slot from the advertisement server 3000, in step S140.

The vehicle controller 1200 may output the received advertisement information to the user interface 1300 during the assigned advertisement time slot in step S150.

The vehicle controller 1200, when an event occurs while the vehicle 1000 is driving (step S160), may be provided with driving information from at least one among the vehicle communicator 1100 mounted in the vehicle 1000, the user interface 1300, the vehicle driver 1400, the driving controller 1500, the sensor 1600, the operator 1700, the navigation 1800, and the vehicle storage 1900, in order to update advertisement time slot information.

The vehicle controller 1200 may pause the advertisement being outputted, and output the advertisement again after completion of the update of the advertisement time slot as the advertisement time slot is updated according to the occurrence of an event. After the advertisement being outputted has ended, the advertisement may be outputted again during the newly assigned advertisement time slot. However, the present disclosure is not limited thereto.

Among events that may occur while the vehicle 1000 is driving, description will be made below on an event that causes an advertisement time slot, specifically an audio advertisement time slot, to be changed.

The vehicle controller 1200 may collect driving information or content information so as to update a time slot appropriate for audio advertising when an input signal related to the output control of audio content, for example, a radio channel change signal, or a content reproduction end signal, is received through the user interface 1300.

The vehicle controller 1200 may update a time slot appropriate for audio advertising by reflecting an advanced driver assistance systems (ADAS) voice guidance output interval or a navigation voice guidance output interval, when driving information provided by at least one among the vehicle communicator 1100, the user interface 1300, and the navigation 1800 is changed.

The vehicle controller 1200 may update a time slot appropriate for audio advertising when a change from the autonomous driving mode to a manual driving mode due to an unexpected situation is sensed in accordance with the driving information provided by at least one among the user interface 1300, the driving controller 1500, and the operator 1700.

The vehicle controller 1200 may update a time slot appropriate for audio advertising when a change in the behavior of the user is sensed through the user interface 1300, for example, a start and an end of sleep, a start and an end of a game, a start and an end of a telephone call, and a start and an end of a conversation.

The vehicle controller 1200 may update a time slot appropriate for audio advertising when a destination change is sensed through the navigation 1800. For example, the vehicle controller 1200 may newly calculate an interval during which the vehicle is in the straight driving mode or the traffic signal waiting mode by reflecting the destination change, and determine the calculated interval as a time slot appropriate for the audio advertising.

Among events that may occur while the vehicle 1000 is driving, description will be made below on an event that causes an advertisement time slot, specifically a video advertisement time slot, to be changed.

The vehicle controller 1200 may update a time slot appropriate for a video by collecting driving information or content information when an input signal related to the output control of video content, for example, a TV channel change signal and a content playback completion or a temporary pause signal, is received through the user interface 1300.

The vehicle controller 1200 may sense an event in which image viewing concentration of a user is lowered, such as when the user is operating at least one of the user interface 1300 or the navigation 1800, when an image captured by a rear camera of the vehicle 1000 is being outputted through the user interface 1300 when the vehicle is moving in reverse, when a Bluetooth telephone call is received, or when the user is waiting for device connection through the vehicle communicator 1100. Based on the sensing result, the vehicle controller 1200 may update a time slot appropriate for the video advertisement.

The vehicle controller 1200 may update a time slot appropriate for the video advertisement when a change from the autonomous driving mode to the manual driving model due to an emergency situation is sensed in accordance with the driving information provided by at least one among the user interface 1300, the driving controller 1500, and the operator 1700.

The vehicle controller 1200 may update a time slot appropriate for the video advertisement when a change in the behavior of the user is sensed through the user interface 1300, such as a start and an end of sleep, a start and an end of a game, a start and an end of a telephone call, and a start and an end of a conversation.

Through the camera 1320 of the user interface 1300, the vehicle controller 1200 may sense a state of the user in which the user may be expected to react negatively when the advertisement is outputted, for example, a state in which the user has entered the vehicle with a baby. Here, the vehicle controller 1200 may update the time slot appropriate for the video advertisement.

The vehicle controller 1200 may update a time slot appropriate for the video advertisement when the route on which the vehicle 1000 is driving is changed through the navigation 1800 according to a destination change or occurrence of an accident. For example, the vehicle controller 1200 may newly calculate a time slot during which the vehicle is in the autonomous driving mode or the traffic signal waiting mode by reflecting the destination change, and determine the calculated time slot as the time slot appropriate for the video advertisement.

FIG. 5 is a view illustrating an operation for setting an advertisement time slot of an advertisement time slot setting apparatus according to an embodiment of the present disclosure.

The method for setting an advertisement time slot according to an embodiment may include operations other than the operations shown and described in FIG. 5, or may not include some of the operations described in FIG. 5 below.

In order to determine an advertisement time slot based on the collected information, the vehicle controller 1200 may determine whether to add or deduct points for each situation as described below. When a score for each interval is added up, and when the score of an interval is higher than a predetermined threshold score, the interval may be determined as an advertisement time slot suitable for the advertisement. The vehicle controller 1200 may charge a high cost to the advertisement server 3000 for the selected advertisement time slot, and charge a higher cost as the score of the interval of the corresponding time slot increases.

As an interval during which the user's degree of concentration on an audio advertisement is expected to increase, in connection with audio content outputted from the sound output unit 1350, an interval pre-designated by an audio streaming or radio content provider and an interval following the end of an audio track in a music playlist may be included. For such an interval, specifically an interval predesignated as an advertisement time slot, the vehicle controller 1200 may assign extra points. For example, as shown in FIG. 5, +10 points may be added to such an interval. The vehicle controller 1200 may replace advertisement information inserted by the audio content provider in the interval designated as the advertisement time slot in audio content such as a podcast with the advertisement information received from the advertisement server 3000, and output the advertisement information.

As an interval during which the user's degree of concentration on an audio advertisement is expected to increase, in connection with a voice guidance in the vehicle 1000 such as a guidance outputted from the navigation 1800, an interval within a few seconds immediately after guidance of the navigation 1800 is outputted, an interval within a few seconds immediately after voice guidance relating to entering or alighting from a vehicle such as a taxi, a ride-hailing vehicle, or a bus is outputted, or an interval within a few seconds immediately after voice guidance generated by a wireless toll payment device or a black box is outputted, may be included. For such an interval, specifically an interval within a few seconds immediately after the guidance of the navigation 1800 is outputted, the vehicle controller 1200 may assign extra points. For example, as shown in FIG. 5, +5 points may be added to such an interval.

Meanwhile, as an interval during which the user's degree of concentration on an audio advertisement is expected to decrease, in connection with the voice guidance in the vehicle 1000 such as the guidance outputted from the navigation 1800, an interval during the guidance output of the navigation 1800, an interval during the voice guidance output relating to entering or alighting from a vehicle such as a taxi, a ride-hailing vehicle, or a bus, during the voice guidance generated by the wireless toll payment device or the black box, or an interval during a service voice broadcast generated during use of a mobility service such as a vehicle sharing service, for example, a welcome broadcast when entering a vehicle and a service use information broadcast during the driving, may be included. For such an interval, specifically an interval during the guidance of a point of interest (POI) of the navigation 1800, the vehicle controller 1200 may deduct points. For example, as shown in FIG. 5, −15 points may be deducted for this interval.

As an interval during which the user's degree of concentration on an audio advertisement is expected to increase, in connection with the state of a passenger detected through the user interface 1300, the operator 1700, and the navigation 1800, an interval during which the vehicle 1000 is in the autonomous driving mode, an interval during which the user is sitting on a passenger seat and not driving the vehicle, or an interval within a few minutes after the user enters the vehicle may be included. For such an interval, specifically while the vehicle 1000 is operating in the autonomous driving mode, the vehicle controller 1200 may assign extra points. For example, as shown in FIG. 5, +10 points may be added to this interval.

As an interval during which the user's degree of concentration on an audio advertisement is expected to decrease, in connection with the state of the passenger detected through the user interface 1300, the operator 1700, and the navigation 1800, an interval during which the user is asleep, or considering that the user may be short on time due to an approaching appointment time, an interval during which arrival at the destination is imminent, may be included. For such an interval, specifically an interval during which the user is asleep, the vehicle controller 1200 may sequentially deduct points. For example, as shown in FIG. 5, −5 points, −10 points, −20 points, −10 points, and −5 points may be sequentially deducted as the time during which the user is asleep passes.

As an interval during which the user's degree of concentration on an audio advertisement is expected to increase, in connection with the route information provided by the navigation 1800, an interval during which a lesser degree concentration is required for driving, for example, a straight driving interval or a traffic signal waiting interval, may be included.

As an interval during which the user's degree of concentration on an audio advertisement is expected to decrease, in connection with the route information provided through the navigation 1800, an interval during which a higher degree of concentration is required for driving, for example, interval of driving on a sharply curved road or at an intersection, may be included.

By summing the assigned scores, the vehicle controller 1200 may calculate the score for each interval, as shown in FIG. 5. When a threshold score is set to 0, the vehicle controller 1200 may determine the intervals calculated as having scores of 10 points, 5 points, 20 points, and 30 points as advertisement time slots.

As an interval during which the user's degree of concentration on a video advertisement is expected to increase, in connection with video content outputted from the display 1340, an interval pre-designated by a provider of video streaming or TV content as an advertisement time slot, an interval during which a real time TV advertisement is broadcast, and an interval following the end of a video track in an video playlist may be included. For such an interval, specifically the interval predesignated as the advertisement interval, the vehicle controller 1200 may assign extra points. For example, +15 points may be added to this interval. The vehicle controller 1200 may replace the advertisement information inserted by the video content provider in the interval designated as an advertisement time slot in video content such as YouTube with advertisement information received from the advertisement server 3000, and output the advertisement information.

As an interval during which the user's degree of concentration on a video advertisement is expected to increase, in connection with output screens of the user interface 1300 and the navigation 1800, an interval during the output of a payment screen such as the payment of the mobility bill, or an interval within a few seconds after the display of the confirmation screen of the user related to destination setting information of the navigation 1800 may be included. For such intervals, specifically an interval during the output of a general guidance screen and an interval during the output of the payment screen of the navigation 1800, the vehicle controller 1200 may assign extra points. For example, +10 points may be assigned.

Meanwhile, as an interval during which the user's degree of concentration on a video advertisement is expected to decrease, in connection with the output screen of the user interface 1300 and the navigation 1800, an interval during which the navigation 1800 outputs a vehicle safety-related screen, for example, in the process of outputting a safety belt wearing guide screen when entering the highway, may be included. For such an interval, the vehicle controller 1200 may deduct −15 points for this interval.

As an interval during which the user's degree of concentration on a video advertisement is expected to increase, in connection with the status of the passenger detected through the user interface 1300, the operator 1700, and the navigation 1800, an interval during which the vehicle 1000 is in the autonomous driving mode, an interval during which the user is sitting on a passenger seat and not driving the vehicle, or an interval within a few minutes after the user enters the vehicle may be included. For such an interval, specifically and interval during which the vehicle 1000 is in the autonomous driving mode, the vehicle controller 1200 may assign extra points. For example, as shown in FIG. 5, +10 points may be added for this interval.

As an interval during which the user's degree of concentration on a video advertisement is expected to increase, in connection with the state of the passenger detected through the user interface 1300, the operator 1700, and the navigation 1800, an interval during which the user enters the vehicle with a baby, an interval during which the user is asleep, or considering that the user may be short on time due to an approaching appointment time, an interval during which arrival at the destination is imminent, may be included. For such an interval, specifically the interval during which the user enters the vehicle with a baby, the vehicle controller 1200 may deduct −5 points for this interval.

As an interval during which the user's degree of concentration on a video advertisement is expected to increase, in connection with the route information provided through the navigation 1800, an interval during which lesser degree concentration is required for driving, for example, a straight or flat road driving interval enabling stable driving, a traffic signal waiting interval, or a highway driving interval with monotonous scenery, may be included. For such an interval, specifically to the highway driving interval, the vehicle controller 1200 may assign an extra +10 points for this interval.

As an interval during which the user's degree of concentration on a video advertisement is expected to decrease, in connection with the route information provided through the navigation 1800, a driving interval such as a road lined with flowers which attracts the user's visual attention, and an unstable driving interval such as an unpaved interval, may be included. For such intervals, specifically the unpaved road driving interval, the vehicle controller 1200 may deduct −10 points. The vehicle controller 1200 may apply a preference model that has been trained using a deep learning method in determining whether the driving interval attracts the user's visual attention.

By summing the assigned scores, the vehicle controller 1200 may calculate the score for each interval, as shown in FIG. 5. When the threshold score is set to 0, the vehicle controller 1200 may determine the intervals calculated as having scores of 10 points, 5 points, 20 points, and 30 points as advertisement time slots.

The vehicle controller 1200 may generate advertisement time slot information by tabulating the calculated scores for each interval as described above, and transmit the generated advertisement time slot information in the form of a table to the advertisement server 3000 through the vehicle communicator 1100.

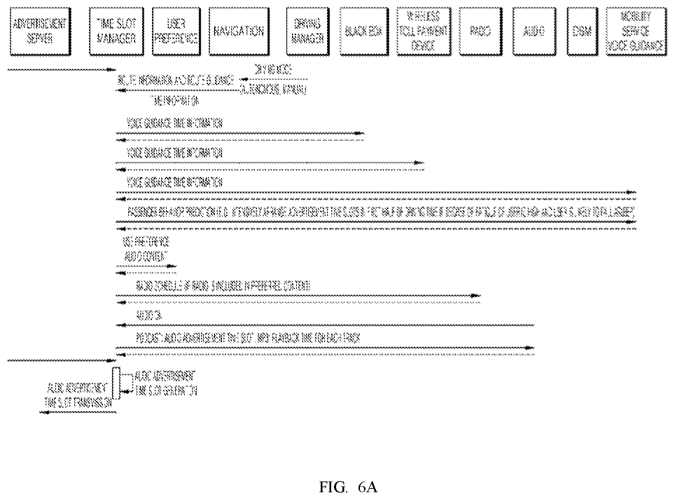

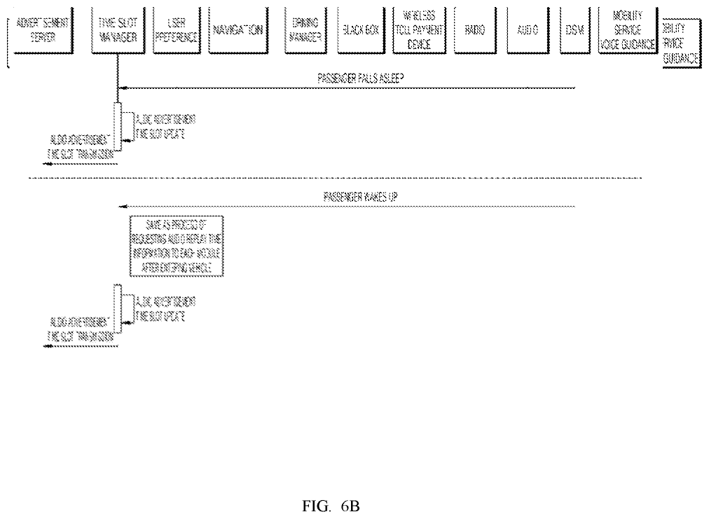

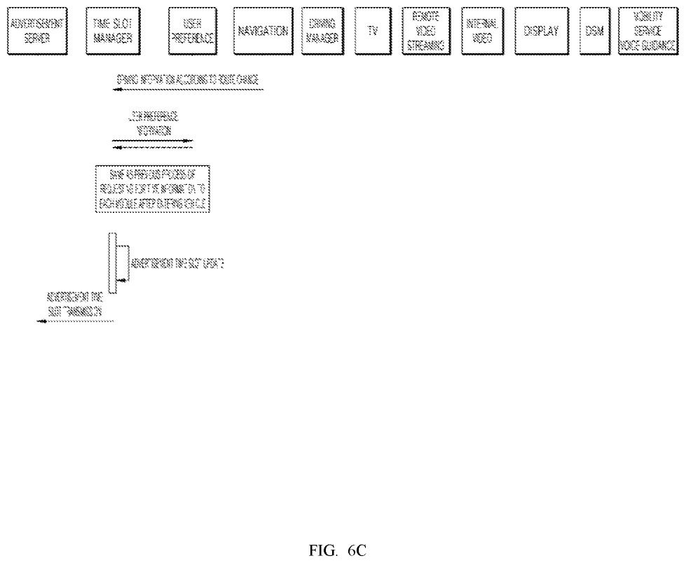

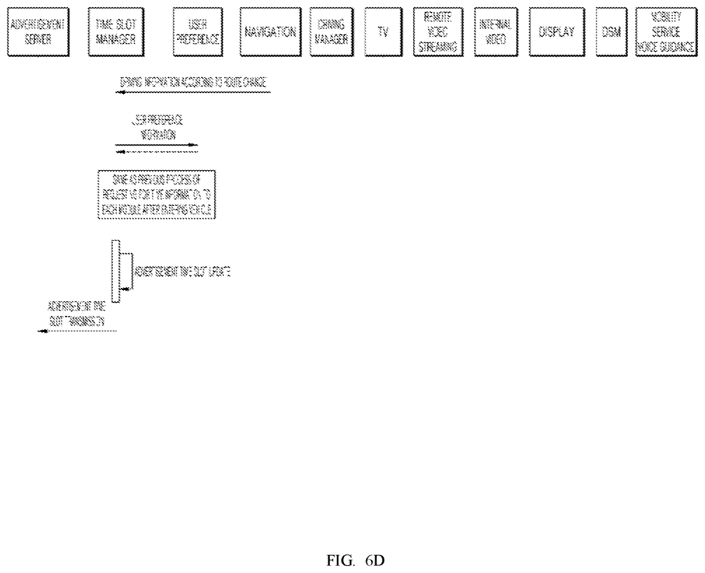

FIGS. 6A to 6D are views illustrating an operation of a system to which an advertisement time slot setting apparatus is applied according to an embodiment of the present disclosure.

Referring to FIG. 6A, the vehicle controller 1200 may receive a request to provide advertisement time slot information from the advertisement server 3000 that recognizes the startup (ON) of the vehicle 1000.

Through a driving manager function, the vehicle controller 1200 may transmit, to the navigation 1800, information on which mode the vehicle 1000 is operating in, between the autonomous driving mode and the manual driving mode.

The navigation 1800 may generate route information and route guidance information based on the information transmitted from the vehicle controller 1200, and provide the generated information to the vehicle controller 1200.

The vehicle controller 1200 may be connected to a mobility service voice guidance module of a black box, a wireless toll payment device, and the user interface 1300 (that is, the sound output unit 1350), as one aspect of a time slot manager function for transmitting and receiving voice guidance time information provided by the navigation 1800.

The vehicle controller 1200 may predict a user's behavior according to information provided from the user interface 1300 in connection with the user interface 1300, as one aspect of the time slot manager function. For example, when it is determined that the degree of fatigue of the user is high based on the information received from the internal camera 1320 of the user interface 1300, the vehicle controller 1200 may determine that the user is likely to fall asleep, and intensively arrange advertisement time slots in the first half of the driving time.

The vehicle controller 1200 may determine an advertisement time slot according to a pre-learned user preference. When it is determined that a user prefers radio content based on the user preference, the vehicle controller 1200 may determine an advertisement time slot by receiving a radio table from a radio module.

When an audio is turned on, the vehicle controller 1200 may receive a turn-on signal from the vehicle output unit 1350. According to the received turn-on signal, the vehicle controller 1200 may identify an advertisement time slot pre-designated by a marker when the content being reproduced is a podcast, and identify a playback time for each track when the content being reproduced is an MP3 file. The vehicle controller 1200 may determine an advertisement time slot based on the identified time information.

When receiving the request for advertisement time slot information transmission from the advertisement server 3000, the vehicle controller 1200 may transmit, through the vehicle communicator 1100, advertisement time slot information according to a predetermined advertisement time slot to the advertisement server 3000.

Referring to FIG. 6B, when occurrence of an event such as a user falling asleep or waking up is sensed, the vehicle controller 1200 may update an advertisement time slot as one aspect of the time slot manager function, and transmit information on the updated advertisement time slot to the advertisement server 3000 through the vehicle communicator 1100.

Referring to FIG. 6C, the vehicle controller 1200 may receive a request to provide advertisement time slot information from the advertisement server 3000 that recognizes the startup (ON) of the vehicle 1000.

Through the driving manager function, the vehicle controller 1200 may transmit, to the navigation 1800, information on which mode the vehicle 1000 is operating in, between the autonomous driving mode and the manual driving mode.

The navigation 1800 may generate route information and route guidance time information based on the information transmitted from the vehicle controller 1200, and provide the generated information to the vehicle controller 1200.

The vehicle controller 1200 may be provided with information on TV content, video streaming content, internally stored video, and a mobility service guide that can be reproduced by the user interface 1300, as one aspect of the time slot manager function.

The vehicle controller 1200 may predict the user's behavior according to the information provided from the user interface 1300 in connection with the user interface 1300, as one aspect of the time slot manager function. For example, when it is determined that the user has entered the vehicle with a baby based on the information received from the internal camera 1320 of the user interface 1300, the vehicle controller 1200 may determine that the user is less likely to focus on the screen, and adjust the advertisement time slot accordingly.

The vehicle controller 1200 may determine an advertisement time slot according to a pre-learned user preference.

When receiving the request for advertisement time slot information transmission from the advertisement server 3000, the vehicle controller 1200 may transmit, through the vehicle communicator 1100, advertisement time slot information according to a pre-determined advertisement time slot to the advertisement server 300.

Referring to FIG. 6D, the vehicle controller 1200 may update an advertisement time slot by incorporating information of each module collected, as one aspect of the time slot manager function, based on driving information according to a route change provided by the navigation 1800 and user preference, and transmit, through the vehicle communicator 1100, the information on the updated advertisement time slot to the advertisement server 3000.

The present disclosure described above may be implemented as a computer-readable code in a medium on which a program is recorded. The computer readable medium includes all types of recording devices in which data readable by a computer system readable can be stored. Examples of the computer readable medium include a hard disk drive (HDD), a solid state disk (SSD), a silicon disk drive (SDD), a read-only memory (ROM), a random-access memory (RAM), CD-ROM, a magnetic tape, a floppy disk, an optical data storage device, and the like, and it may also be implemented in the form of a carrier wave (for example, transmission over the Internet). In addition, the computer may include a processor or a controller. Therefore, the above description should not be construed as limiting and should be considered illustrative. The scope of the present disclosure should be determined by rational interpretation of the appended claims, and all changes within the scope of equivalents of the present disclosure are included in the scope of the present disclosure.

What is claimed is:

1. An apparatus for setting an advertisement time slot, the apparatus transmitting and receiving data in connection with a vehicle device which provides driving information up to a destination of a vehicle and an advertisement server, and comprising:
a communicator configured to communicate with the advertisement server;
an output unit configured to output at least one of an image or a sound; and
a controller configured to receive driving information from the vehicle device, determine an advertisement time slot based on the driving information, and
generate advertisement time slot information, which is information on the determined advertisement time slot,
wherein the communicator is further configured to transmit the advertisement time slot information generated by the controller to the advertisement server, and receive advertisement information assigned to the advertisement time slot from the advertisement server, and
wherein the controller is further configured to cause the output unit to output the received advertisement information during the advertisement time slot to which the received advertisement information is assigned.

2. The apparatus of claim 1, wherein the controller is further configured to determine an interval as the advertisement time slot when the interval is determined as an interval during which driving information related guidance according to a driving route of the vehicle is not being outputted, based on the driving information.

3. The apparatus of claim 1, wherein the controller is further configured to determine an interval as the advertisement time slot when the interval is determined as an interval during which the vehicle is in an autonomous driving mode, based on the driving information.

4. The apparatus of claim 1, wherein the controller is further configured to determine an interval as the advertisement time slot when the interval is determined as an interval during which the vehicle is in a straight driving mode, based on the driving information.

5. The apparatus of claim 1, wherein the controller is further configured to determine an interval as the advertisement time slot when the interval is determined as an interval during which the vehicle is in a traffic signal waiting mode, based on the driving information.

6. The apparatus of claim 1, further comprising a storage configured to store content in a form of at least one of an image or a sound,
and wherein the apparatus is configured to determine an interval as a first candidate time slot when the interval is determined as an interval during which driving information related guidance according to a driving route of the vehicle is not being outputted, based on the driving information, receive the content from the storage, and determine an interval in the first candidate time slot that overlaps with an advertisement insertion interval in the content as the advertisement time slot.

7. The apparatus of claim 1, further comprising a storage configured to store a plurality of content in a form of at least one of an image or a sound,
wherein the apparatus is configured to determine an interval as a first candidate time slot when the interval is determined as an interval during which driving information related guidance according to a driving route of the vehicle is not being outputted, based on the driving information, receive the plurality of content from the storage, and determine an interval in the first candidate time slot that overlaps with an interval before a start of a next item of content after one item of content among the plurality of content ends as the advertisement time slot.

8. A method for setting an advertisement time slot in an advertisement time slot setting apparatus for transmitting and receiving data in connection with a vehicle device which provides driving information up to a destination of a vehicle and an advertisement server, the method comprising acts of:
receiving driving information from the vehicle device and determining an advertisement time slot based on the driving information;
generating advertisement time slot information, which is information on the advertisement time slot determined by the act of receiving driving information and determining an advertisement time slot;
transmitting the advertisement time slot information to the advertisement server and receiving advertisement information assigned to the advertisement time slot from the advertisement server; and
outputting the received advertisement information during the advertisement time slot to which the received advertisement information is assigned.

9. The method of claim 8, wherein act of receiving driving information and determining an advertisement time slot comprises:
receiving driving information from the vehicle device; and
determining an interval during which driving information related guidance according to a driving route of the vehicle is not being outputted as the advertisement time slot, based on the driving information.

10. The method of claim 8, wherein the act of receiving driving information and determining an advertisement time slot comprises:
receiving driving information from the vehicle device; and
determining an interval during which the vehicle is in an autonomous driving mode as the advertisement time slot, based on the driving information.

11. The method of claim 8, wherein act of receiving driving information and determining an advertisement time slot comprises:
receiving driving information from the vehicle device; and
determining an interval during which the vehicle is in a straight driving mode as the advertisement time slot, based on the driving information.

12. The method of claim 8, wherein act of receiving driving information and determining an advertisement time slot comprises:
receiving driving information from the vehicle device; and
determining an interval during which the vehicle is in a traffic signal waiting mode as the advertisement time slot, based on the driving information.

13. The method of claim 8, further comprising storing content in a form of at least one of an image or a sound,
and wherein the act of receiving driving information and determining an advertisement time slot comprises:
receiving driving information from the vehicle device; and
based on the driving information, determining an interval that overlaps with an advertisement insertion interval in the content, during an interval during which driving information related guidance according to a driving route of the vehicle is not being outputted, as the advertisement time slot.

14. The method of claim 8, further comprising storing a plurality of content in the form of at least one of an image or a sound,
and wherein the act of receiving driving information and determining an advertisement time slot comprises:
receiving driving information from the vehicle device; and
based on the driving information, determining an interval that overlaps with an interval before a start of a next item of content after one item of content among the plurality of content ends, during an interval during which driving information related guidance according to a driving route of the vehicle is not being outputted, as the advertisement time slot.

15. A computer readable recording medium recording a program, as a recording medium for setting an advertisement time slot in an advertisement time slot setting apparatus for transmitting and receiving data in connection with a vehicle device which provides driving information up to a destination of a vehicle and an advertisement server, the computer readable recoding medium recording a program comprising:
a first means configured to receive driving information from the vehicle device and determine an advertisement time slot based on the driving information;
a second means configured to generate advertisement time slot information, which is information on the advertisement time slot determined by the first means;
a third means configured to transmit the advertisement time slot information to the advertisement server and receive advertisement information assigned to the advertisement time slot from the advertisement server; and
a fourth means configured to output the received advertisement information during the advertisement time slot to which the received advertisement information is assigned.
